(19) United States
(12) Patent Application Publication
(10) Pub. No.: US 2020/0280104 A1
(43) Pub. Date: Sep. 3, 2020

(54) Anode Subassemblies for Lithium-Metal Batteries, Lithium-Metal Batteries Made Therewith, and Related Methods

(71) Applicant: SES Holdings Pte. Ltd., Singapore (SG)

(72) Inventors: Yongkyu Son, Bedford, MA (US); Jacqueline Hong, Stoneham, MA (US); Qichao Hu, Arlington, MA (US)

(21) Appl. No.: 16/804,064

(22) Filed: Feb. 28, 2020

Related U.S. Application Data
(60) Provisional application No. 62/812,472, filed on Mar. 1, 2019.
(60) Provisional application No. 62/830,620, filed on Apr. 8, 2019.
(60) Provisional application No. 62/832,665, filed on Apr. 11, 2019.

(51) Int. Cl. H01M 10/0587; H01M 10/052; H01M 2/16

(52) U.S. Cl. CPC H01M 10/0587; H01M 2/1646; H01M 2/1686; H01M 10/052

(57) ABSTRACT

Anode subassembly sheets that include a lithium-metal layer sandwiched between a pair of separator layers to ease handling of the lithium metal to promote fast and efficient stacked-jellyroll assembly. In some embodiments, the separator layers are pressure laminated to the lithium-metal layer without any bonding agent. In some embodiments, a stacked jellyroll is made by alternatingly stacking anode subassembly sheets with cathode sheets. In some embodiments, a functional coating beneficial to the lithium-metal layer is provided to one or more separator layers prior to laminating the separator(s) to the lithium metal layer. Lithium-metal batteries made using stacked jellyrolls made in accordance with aspects of the disclosure are also described.

### RELATED APPLICATION DATA

This application claims the benefit of priority of U.S. Provisional Patent Application Ser. No. 62/812,472, filed Mar. 1, 2019, and titled “NEW STACK JELLY-ROLL STRUCTURE USING LAMINATION ON LITHIUM-METAL ANODE”, and U.S. Provisional Patent Application Ser. No. 62/830,620, filed Apr. 8, 2019, and titled “NEW STACK JELLY-ROLL STRUCTURE USING LAMINATION ON LITHIUM-METAL ANODE”, and U.S. Provisional Patent Application Ser. No. 62/832,665, filed Apr. 11, 2019, and titled “NEW STACK JELLY-ROLL STRUCTURE USING LAMINATION ON LITHIUM-METAL ANODE”, each of which is incorporated by reference herein in its entirety.

### FIELD OF THE INVENTION

The present invention generally relates to the field of electrochemical devices. In particular, the present invention is directed to anode subassemblies for lithium-metal batteries, lithium-metal batteries made therewith, and related methods.

### BACKGROUND

Because of their high gravimetric and volumetric energy densities, lithium-metal batteries have the potential of becoming the batteries of choice for many applications where such properties are desirable, including electric vehicles and mobile electronic devices, among others. However, the manufacturing of lithium-metal batteries has challenges that must be overcome to make the costs of producing lithium-metal batteries economically viable. Several challenges stem from inherent properties of lithium metal. Lithium metal is a pyrophoric metal that is challenging to work with, especially in the context of large-scale manufacturing, due to its “stickiness,” lightness, and softness, particularly when handling and processing the thin layers (e.g., less than 20 microns) that can be desirable to use in commercial-grade lithium-metal batteries.

### SUMMARY OF THE DISCLOSURE

In some aspects, the present disclosure is directed to a method of making a lithium-metal battery. The method includes assembling a stacked jellyroll, the assembling of the stacked jellyroll including: providing a plurality of anode-subassembly sheets each comprising a lithium-metal layer pressure laminated between a first separator and a second separator; providing a plurality of cathode sheets; and alternatingly stacking the anode-subassembly sheets and the plurality of cathode sheets with one another so as to form the stacked jellyroll.

In one or more embodiments of the method, forming the anode-subassembly sheets, wherein the forming includes: forming a laminated web comprising the first separator, the lithium-metal layer, and the second separator; and cutting the laminated web so as to form the anode-subassembly sheets.

In one or more embodiments of the method, forming the laminated web includes contacting the first and second separators with the lithium-metal to form a multilayer structure, and applying pressure to the multilayer structure to form the laminated web.

In one or more embodiments of the method, applying pressure to the multilayer structure includes feeding the multilayer structure through pinch rollers.

In one or more embodiments of the method, the first separator includes a functional coating for the lithium-metal layer and the functional coating is in contact with the lithium-metal layer.

In one or more embodiments of the method, the functional coating includes a ceramic material.

In one or more embodiments of the method, the functional coating includes lithium fluoride.

In one or more embodiments of the method, the functional coating includes lithium carbonate.

In one or more embodiments of the method, forming the anode-subassembly sheets, wherein the forming includes: forming a laminated web comprising the first separator, the lithium-metal layer, and the second separator, wherein the first separator includes functional coating in contact with the lithium-metal layer; and cutting the laminated web so as to form the anode-subassembly sheets.

In one or more embodiments of the method, forming the laminated web includes contacting the first and second separators with the lithium-metal to form a multilayer structure, and applying pressure to the multilayer structure to form the laminated web.

In one or more embodiments of the method, applying the functional coating to a porous separator body so as to form the first separator.

In one or more embodiments of the method, the functional coating includes a ceramic material.

In one or more embodiments of the method, the functional coating includes lithium fluoride.

In one or more embodiments of the method, the functional coating includes lithium carbonate.

In one or more embodiments of the method, applying pressure to the multilayer structure includes feeding the multilayer structure through pinch rollers.

In one or more embodiments of the method, placing the stacked jellyroll in an interior of a casing.

In one or more embodiments of the method, adding an electrolyte to the interior of the casing and sealing the casing.

In one or more embodiments of the method, the lithium-metal layer has a thickness less than 20 microns.

In one or more embodiments of the method, the lithium-metal layer has a thickness less than 10 microns.

In one or more embodiments of the method, the lithium-metal layer has a sheet area and the anode-subassembly sheet further comprising a current-collector layer in contact with the lithium-metal layer across the sheet area.

In one or more embodiments of the method, the current-collector layer is embedded in the lithium-metal layer so that lithium metal is present on both sides of the current-collector layer.

In some aspects, the present disclosure is directed to a method of making an anode subassembly. The method includes providing a lithium-metal layer having a first side and a second side opposite the first side; providing a first separator having a functional coating for the lithium metal layer; contacting the functional coating and the first side of the lithium-metal layer with one another; and pressure laminating the first separator and the lithium-metal layer with one another to form the anode subassembly.

In one or more embodiments of the method, applying the functional coating to a porous separator body so as to form the first separator.

In one or more embodiments of the method, the pressure laminating uses pinch rollers.

In one or more embodiments of the method, the method is performed in a roll-to-roll process.

In one or more embodiments of the method, the functional coating includes a ceramic material.

In one or more embodiments of the method, the functional coating includes lithium fluoride.

In one or more embodiments of the method, the functional coating includes lithium carbonate.

In one or more embodiments of the method, providing a second separator; contacting the second separator and the second side of the lithium-metal layer with one another; and pressure laminating the first separator, the lithium-metal layer, and the second separator with one another to form the anode subassembly.

In one or more embodiments of the method, the lithium-metal layer has a sheet area and the anode-subassembly sheet further comprising a current-collector layer in contact with the lithium-metal layer across the sheet area.

In one or more embodiments of the method, the current-collector layer is embedded in the lithium-metal layer so that lithium metal is present on both sides of the current-collector layer.

In some aspects, the present disclosure is directed to an anode assembly, including a lithium-metal layer having a first side and a second side opposite the first side; and a first separator having a face and a functional coating for the lithium-metal layer applied to the face, wherein the first separator is pressure laminated to the lithium-metal layer on the first side of the lithium-metal layer with the functional coating in contact with the lithium-metal layer.

In one or more embodiments of the anode, the functional coating includes a ceramic material.

In one or more embodiments of the anode, the functional coating includes lithium fluoride.

In one or more embodiments of the anode, the functional coating includes lithium carbonate.

In one or more embodiments of the anode, the lithium-metal layer has a thickness less than 20 microns.

In one or more embodiments of the anode, the lithium-metal layer has a thickness less than 10 microns.

In one or more embodiments of the anode, a second separator pressure laminated with the lithium-metal layer on the second side of the lithium-metal layer.

In one or more embodiments of the anode, the lithium-metal layer has a sheet area and the anode-subassembly sheet further comprising a current-collector layer in contact with the lithium-metal layer across the sheet area.

In one or more embodiments of the anode, the current-collector layer is embedded in the lithium-metal layer so that lithium metal is present on both sides of the current-collector layer.

In some aspects, the present disclosure is directed to a lithium-metal battery, including a core stack that includes a plurality of anode-subassembly sheets and a plurality of cathode sheets alternatingly stacked with the anode-subassembly sheets; wherein each of the anode-subassembly sheets includes: a lithium-metal layer having a first side and a second side opposite the first side; a first separator pressure laminated to the lithium-metal layer on the first side of the lithium metal layer; and a second separator pressure laminated with the lithium metal layer on the second side of the lithium-metal layer; an electrolyte solution; and a casing containing the core stack and the electrolyte solution so that the electrolyte solution saturates the first and second separators of the anode assembly sheets.

In one or more embodiments of the lithium-metal battery, the first separator includes a functional coating for the lithium-metal layer, and the first separator is pressure laminated to the lithium-metal layer so that the functional coating is in contact with the lithium-metal layer.

In one or more embodiments of the lithium-metal battery, the functional coating includes a ceramic material.

In one or more embodiments of the lithium-metal battery, the functional coating includes lithium fluoride.

In one or more embodiments of the lithium-metal battery, the functional coating includes lithium carbonate.

In one or more embodiments of the lithium-metal battery, the lithium-metal layer has a thickness less than 20 microns.

In one or more embodiments of the lithium-metal battery, the lithium-metal layer has a thickness less than 10 microns.

In one or more embodiments of the lithium-metal battery, the lithium-metal layer has a sheet area and the anode-subassembly sheet further comprising a current-collector layer in contact with the lithium-metal layer across the sheet area.

In one or more embodiments of the lithium-metal battery, the current-collector layer is embedded in the lithium-metal layer so that lithium metal is present on both sides of the current-collector layer.

### BRIEF DESCRIPTION OF THE DRAWINGS

For the purpose of illustrating examples of the present disclosure, the drawings show aspects of one or more embodiments of the invention(s). However, it should be understood that the present invention(s) is/are not limited to the precise arrangements and instrumentalities shown in the drawings, wherein:

FIG. 1 is a diagram illustrating a conventional Z-fold stacking process for making a Z-fold stacked jellyroll for a lithium-metal battery;

FIG. 2A is a diagram illustrating an example direct-stacking process for making a directly stacked jellyroll for a lithium-metal battery, wherein the stacking process includes alternatingly stacking anode-subassembly sheets and cathode sheets with one another;

FIG. 2B is an enlarged partial cross-sectional view of an example of the anode-subassembly sheets of FIG. 2A illustrating the first and second separator layers pressure laminated to the lithium-metal layer;

FIG. 2C is a diagram illustrating an example method of making an anode-subassembly web that can be a precursor to the anode-subassembly sheets of FIGS. 2A and 2B;

FIG. 2D is an enlarged partial cross-sectional view of an example of the cathode sheet of FIG. 2A;

FIG. 2E is an enlarged partial cross-sectional view of an example alternative anode-subassembly sheet that includes a current-collector layer;

FIG. 3A is an exploded side view of an example anode-assembly sheet that includes a functional coating for a lithium-metal layer applied to at least one separator layer prior to pressure-laminating the separator layer(s) and lithium-metal layer with one another;

FIG. 3B is a longitudinal cross-sectional view of the anode-assembly sheet of FIG. 3A after the separator layer(s) and the lithium-metal layer have been pressure laminated with one another;

FIG. 3C is a diagram illustrating an example method of making a precursor anode-subassembly web to the anode-subassembly sheet of FIG. 3B; and

FIG. 4 is a cross-sectional view of an example lithium-metal battery having a directly stacked jellyroll made in accordance with the present disclosure.

### DETAILED DESCRIPTION

In some aspects, the present disclosure is directed to methods of making directly stacked jellyrolls for lithium-metal batteries and making lithium-metal batteries using such stacked jellyroll. In some aspects, the present disclosure is directed to the stacked jellyrolls and batteries themselves. In some aspects, the present disclosure is directed to methods of making anode subassemblies that have one or more functional coatings for a lithium metal layer pre-applied to one or more separators prior to contacting the functional coating with the lithium metal layer to make an anode subassembly. In some aspects, the present disclosure is directed to such anode subassemblies themselves. Examples of these and other methods are presented below. It is noted that while the examples presented in this disclosure are largely directed to lithium metal batteries having lithium metal anodes, the general methods, techniques, structures, etc., are applicable to other lithium-metal-based electrochemical devices, such as supercapacitors. In addition, the lithium metal in any of the present examples and embodiments may be replaced by one or more other active alkali metals, such as sodium magnesium, and/or aluminum, among others, and any suitable alloy thereof.

Example Directly Stacked Jellyroll

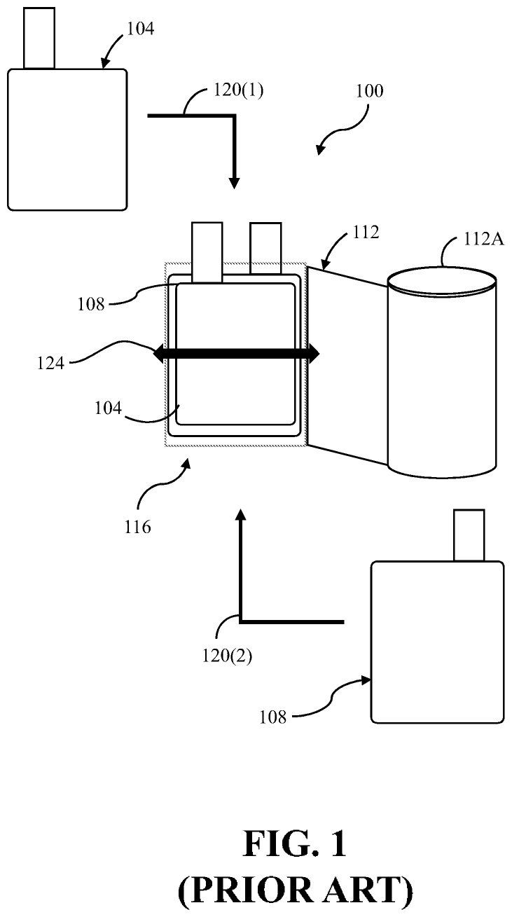

FIG. 1 depicts a conventional stacking process 100 for making stacked jellyrolls for lithium-metal batteries. This conventional stacking process 100 involves alternatingly stacking cathode sheets 104 with anode sheets 108 while feeding out a continuous separator web 112 from a roll 112A to form a stacked jellyroll 116, with a portion of the separator web sandwiched between each pair of the cathode and anode sheets. The stacking is accomplished by alternatingly adding individual cathode sheets 104 and anode sheets 108 (the adding represented by arrows 120(1) and 120(2), respectively) and moving one, the other, or both of the growing stacked jellyroll 116 and roll 112A back and forth (in this example, arrow 124 represents back-and-forth movement of the stacked jellyroll) so that the separator web 112 wraps around one lateral side of each of the cathode and anode sheets and becomes sandwiched between pairs of the cathode sheets and anode sheets as the stacking continues. As one can readily envision, due to the zig-zag shape of the continuous separator web 112 in the finished stacked jellyroll 116, this process is often referred to as a “zigzag stacking process” or a “Z-fold stacking process.”

The machinery (not shown) required to perform this conventional stacking process 100 is fairly complex not only due to the machinery needing to move the stacked jellyroll 116 and/or roll 112A of the continuous separator web 112 to create the zigzag configuration, but also due to the machine needing to do this in coordination with placing of the cathode and anode sheets 104 and 108, respectively, into the growing stack. For contemporary and future lithium-metal batteries that utilize quite-thin layers of lithium metal (e.g., on the order of 20 microns or 10 microns or less), the machinery for performing a conventional Z-fold stacking process, such as the conventional stacking process 100 of FIG. 1, must also be designed to handle extremely delicate lithium-metal anode sheets. As mentioned in the Background section above, lithium metal has a number of physical properties that make it extremely challenging to handle and process. Indeed, the fragility of contemporary and future lithium-metal anodes often requires specialized components and the need to limit the speed at which the machinery can operate. This fact, along with the complexity of operation concomitant the complexity of the machinery results in the machinery taking a fair amount of time to complete the stacking process for each stacked jellyroll it makes.

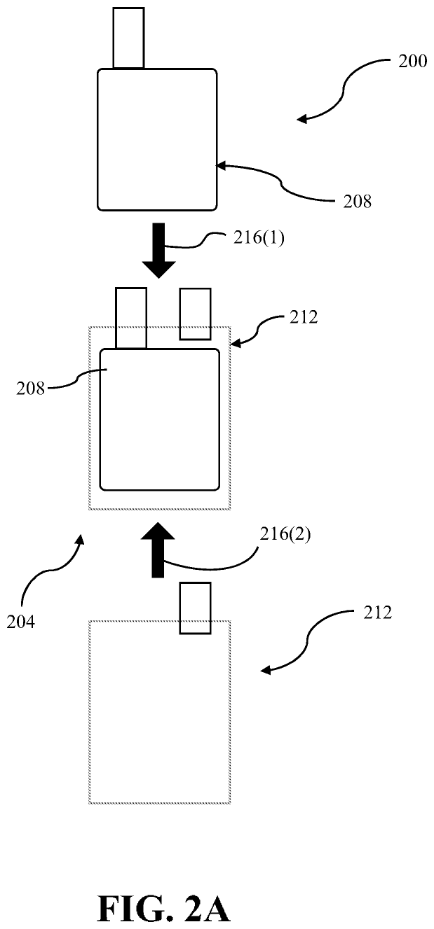

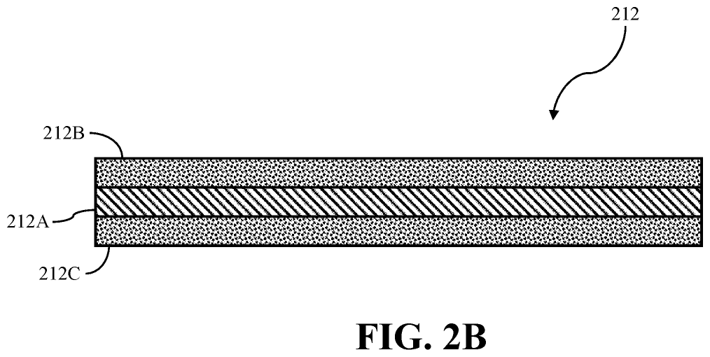

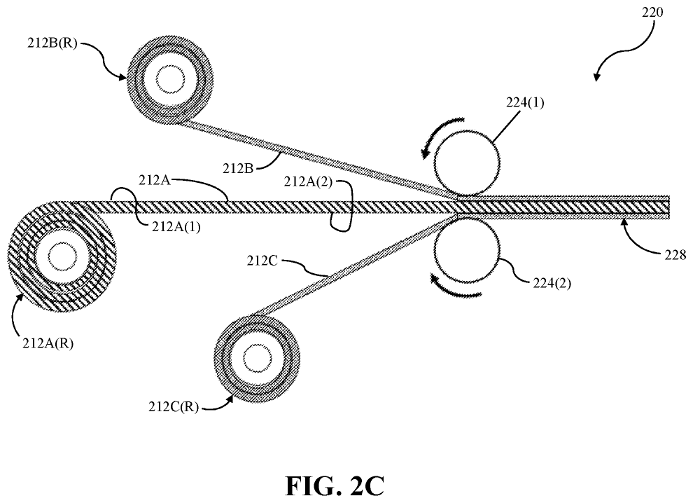

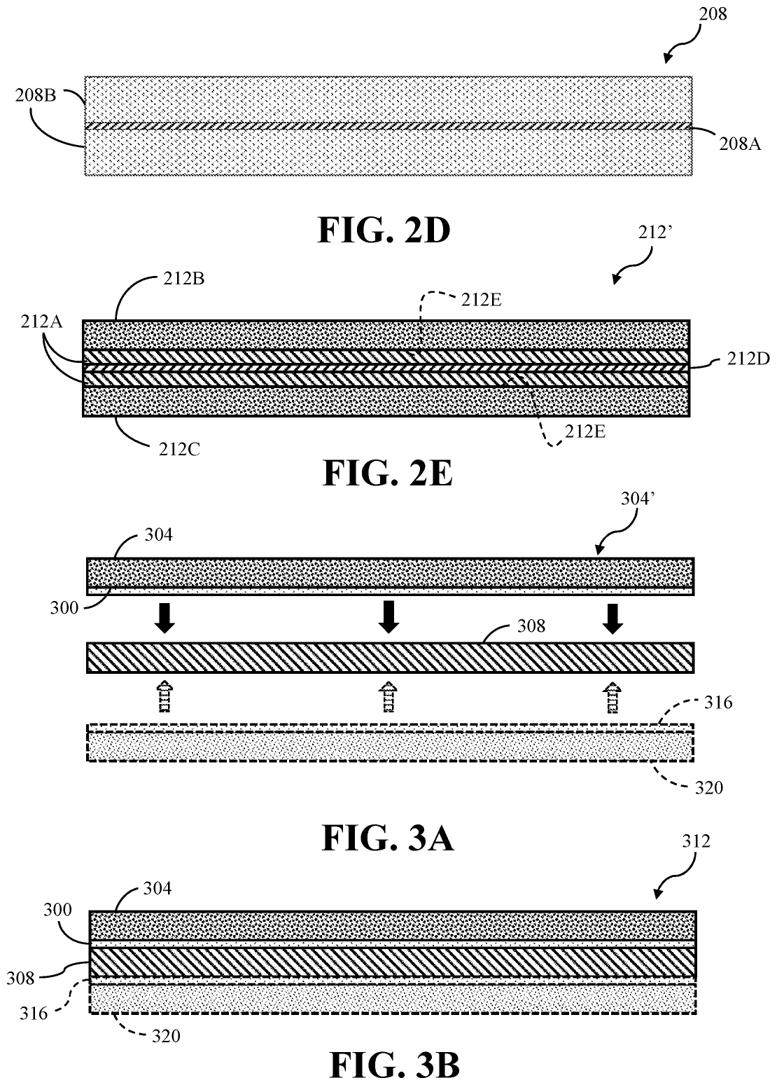

FIG. 2A illustrates an example direct-stacking method 200 that can be used to make a directly stacked jellyroll 204. As will become apparent from reading this section, machinery (not shown) for performing the direct-stacking method 200 can be far less complex than machinery for performing the Z-folding process of the conventional stacking method 100 of FIG. 1. This is so because the machinery for the direct-stacking method 200 does not provide a separator as a separate and distinct component in the stacking process. Consequently, separator-handling components are not needed, nor are actuators and/or other components/features for moving the stacked jellyroll 116 (FIG. 1) and/or the separator roll 112A (FIG. 1). In addition, and as described below, machinery for the direct-stacking method 200 of FIG. 2B does not directly handle a lithium-metal anode and thus does not need to be specially designed to handle the fragility of such an anode.

Referring to FIG. 2A, the example direct-stacking method 200 involves alternatingly adding only two types of components to the growing stacked jellyroll 204, namely cathode sheets 208 and anode-subassembly sheets 212 (the adding represented by arrows 216(1) and 216(2), respectively). Stacking only two types of components with one another greatly simplifies the process of making stacked jellyrolls for use in batteries, especially lithium-metal batteries but also other types of active-metal batteries.

This highly simplified stacking process of the direct-stacking method 200 is enabled by the construction of the anode-subassembly sheets 212 that, as seen in FIG. 2B, includes a lithium-metal layer 212A sandwiched between two separator layers 212B and 212C. It is noted that for convenience, the two separator layers 212B and 212C may also be referred to herein and in the appended claims, respectively, as a “first separator” or a “first separator layer” and a “second separator” or a “second separator layer”. No meaning should be given to “first” and “second” in these terms other than providing a convenient way to identify the two as being separate from one another. As illustrated in FIG. 2C, in some embodiments, the separator layers 212B and 212C are pressure laminated onto the lithium-metal layer 212A, for example, in a continuous web-forming process 220 utilizing pinch rollers, such as pinch rollers 224(1) and 224(2). The pinch rollers 224(1) and 224(2) and/or their corresponding support mechanisms (not shown) are adjusted to provide an amount of pressure sufficient to adhere the separator layers 212B and 212C to the lithium-metal layer 212A. Typically, the adhesion is a direct adhesion of separator layers 212B and 212C to the lithium-metal layer 212A; no separate adhesive or other bonding agent is used for direct adhesion. Such direct adhesion is promoted by the relative softness of the lithium metal in the lithium-metal layer. In some embodiments, the ranges of pressure and temperature that optimize results are 10° C. to 60° C. and 100 lbf/in (175 N/cm) to 1000 lbf/inch (1750 N/cm), respectively. Generally, the optimal values typically depend on the coated materials.

In the continuous-web forming process 220 illustrated in FIG. 2C, the lithium-metal layer 212A is paid-out from a lithium-metal roll 212A(R), and each of the first and second separator layers 212B and 212C are paid-out, respectively from a first separator roll 212B(R) and a second separator roll 212C(R). As the layers 212A, 212B, and 212C are paid out, they are brought into contact with one another and pinch-rolled by pinch rollers 224(1) and 224(2) so that they are pressure laminated to or with one another so as to form a continuous anode-subassembly web 228. The anode-assembly web 228 may then be cut, for example, punched, die cut, sheared, etc., to form the anode-assembly sheets 212 for using in the direct-stacking process 200 of FIG. 2A.

Referring to FIG. 2B, as those skilled in the art know, each of the first and second separator layers 212B and 212C provide physical and electrical separation between an anode, here, the lithium-metal layer 212A, and a cathode, here, one of the cathode sheets 208 (FIG. 2A) in the stacked jellyroll 204, while allowing for ionic flow within an electrolyte (not shown) between the anode and cathode. Each of the separator layers 212B and 212C may be made of any suitable material(s), such as polyethylene, polypropylene, and/or a mixture of ceramic blended polyolefin materials, and any combination thereof, among others. Though not illustrated, in some embodiments each of the separator layers 212B and 212C may incorporate thermal-shutdown capability. In some embodiments, the thickness of each separator layer 212B, 212C may be in a range of 10 to 30 um, though other thicknesses may be used to suit a particular design. As noted above, the use of anode-subassembly sheets having separator layers adhered to a lithium-metal layer, such as anode-subassembly sheets 212, is particularly desirable for use with thin layers of lithium metal, such as lithium-metal layers having thicknesses of 50 microns or less, 20 microns or less, or 10 microns or less. However, the lithium-metal layer 212A may be greater than 50 microns for other applications.

In one example in which each of the first and second separator layers 212B and 212C are made of a porous blend of an inorganic material (e.g., Al₂O₃) and polyethylene, providing the lithium-metal layer 212A in the composite anode-subassembly sheet 212 greatly increases the ease with which the lithium-metal layer can be handled. Lithium metal has a very low tensile modulus of 0.81 MPa, which is a result of its physical softness (melting temperature of 180° C.). After pressure laminating the lithium-metal layer 212A with the first and second separator layers 212B and 212C, the tensile modulus of the composite anode-assembly sheet 212 is on the order of 30 MPa to 50 MPa, an increase of over 2 orders of magnitude over the corresponding bare lithium-metal anodes used in a conventional Z-fold stacking process, such as conventional stacking process 100 of FIG. 1.

In addition, a bare lithium-metal anode is difficult to cut and stack due to its sticky nature. During die cutting and stacking, the bare lithium-metal anodes tend to stick to cutting and handling components of cutting and stacking machinery and are thereby easily damaged. Due to its fragility, cutting and handling machines need to be run at relatively low speeds to enhance the control of the very fragile lithium metal. However, when utilizing anode-subassembly sheets, such as anode-subassembly sheets 212 of FIGS. 2A and 2B, the lithium metal (e.g., lithium-metal layer 212A) is covered by the separator layers, here separator layers 212B and 212C, on both sides (see, e.g., first and second sides 212A(1) and 212A(2) of FIG. 2C) of the lithium-metal layer generally across the entire sheet area. This minimizes the extent of the lithium metal exposed to cutting, handling, and stacking machinery, thereby minimizing detrimental interactions between the lithium metal and such machinery. This, in conjunction with the robustness of the anode-subassembly sheets 212, allows the machinery to operate at much greater speeds as compared to machinery handling bare lithium-metal anodes, as in conventional stacking processes. The Table below illustrates the beneficial effects of the higher-speed operations and simplified stacking of a direct-stacking process of the present disclosure, such as direct-stacking process 200 of FIG. 2A, versus a conventional Z-fold stacking process, such as conventional process 100 of FIG. 1.

TABLE

| | Bare Li-Metal Anodes | Anode Subassemblies |
|---|---|---|
| Task | (parts per minute) | (parts per minute) |
| Cutting to form anode | 30 | 100 |
| structures | | |
| Complete stacks of 23 anodes | 0.2 (Z-fold separator) | 2 (direct stacking) |
| and 24 cathodes | | |

As can be seen in the Table above, in this example the speed of cutting the anode structures is more than tripled when using the composite anode-subassembly sheets of the present disclosure, such as the anode-subassembly sheets 212 of FIGS. 2A and 2B. The Table also shows that, when using the composite anode-subassembly sheets of the present disclosure to make a directly stacked jellyroll having 23 anodes and 24 cathodes, the stacking speed is ten times faster than when using conventional bare lithium-metal anodes.

Referring to FIGS. 2A and 2B, each cathode sheet 208 may be made of any material(s) suitable for providing a cathode compatible with the lithium-metal-based anode assembly sheet 212 and the particular electrolyte used in the final battery (not shown) utilizing the stacked jellyroll 204. In one example, illustrated in FIG. 2D, each cathode sheet 208 includes an aluminum foil layer 208A as a positive substrate. The foil layer 208A is coated on both sides with a slurry containing a high-nickel NMC811 (88% lithium nickel, 11% manganese, and 11% cobalt), a polymer binder (here, polyvinylidene difluoride (PVDF), and a conductive carbon to provide active cathode layers 208B on both sides of the foil layer. Other than suitability of the particular chemistry at issue, there are generally no constraints on the construction and manufacture of the cathode sheets 208.

It is noted that while FIG. 2C illustrates a particular arrangement of a pair of pinch rollers 224(1) and 224(2), those skilled in the art will readily understand that other arrangements are possible, including arrangements that include more than one set of pinch rollers. For example, one or more additional sets of pinch rollers may be provided that sequentially increase the pressure applied to the anode-subassembly web 228. It is further noted the pressure laminating may be performed in a manner other than using pinch rollers. For example, the lithium-metal layer 212A and the first and second separator layers 212B and 212C may be pressure laminated with one another using a stationary press (not shown). In this example, the stationary press may be configured to pressure laminate the first and second separator layers 212B and 212C to the lithium-metal layer 212A in discrete lengths. For example and referring to FIG. 2C, the three layers 212A, 212B, and 212C may be paid-out from corresponding rolls 212A(R), 212B(R), and 212C(R) to form a loose stack (not shown), and the loose stack may then be pressed in the stationary press to form the anode-subassembly web 228. In some embodiments, the anode-subassembly web 228 may then be cut as described above to form the anode-subassembly sheets 212 (FIGS. 2A and 2B).

While the example anode-subassembly sheet 212 of FIGS. 2A and 2B have only a lithium-metal layer 212A, other embodiments may include one or more additional layers sandwiched between the first and second separator layers 212B and 212C. For example, FIG. 2E shows an anode-subassembly sheet 212′ that includes a current-collector layer 212D located within the lithium-metal layer 212A. The current-collector layer 212D may be made of any suitable conductive material, such as copper or aluminum, among others. In addition, the current collector may be solid or perforated, depending on the particular design at issue. In some embodiments, an optional bonding agent 212E (FIG. 2E) may be used to assist with securing one or both of the separator layers 212B and 212C to the lithium-metal layer 212A. This alternative anode-subassembly sheet 212′ may be substituted for the anode-subassembly sheet 212 in the direct-stacking process 200 of FIG. 2A.

In connection with embodiments of the anode-subassembly sheets having one or more additional layers, such as the embodiment of FIG. 2E that has a current-collector layer 212D located between the first and second separator layers 212B and 212C, it is noted for clarity that various terms have particular meanings. Regarding the term “lithium-metal layer”, for convenience, this term shall mean the totality of the lithium metal present between the first and second separator layers 212B and 212C. This is straightforward in the context of the embodiments of FIG. 2B in which each lithium-metal layer 212A is either the only layer between the first and second separator layers 212B and 212C (FIG. 2B) or is only on one side of the current-collector layer 212D. However, the term “lithium-metal layer” is deemed to also apply to the embodiment of FIG. 2E to describe the total thickness of the lithium metal between the first and second separator layers 212B and 212C, despite the fact that when the current-collector layer 212D is a solid layer, the lithium metal forms two discrete layers, one on either side of the current-collector layer. In this case, each such separate lithium-metal layer may be considered a sublayer and/or the current-collector layer 212D may be considered to be embedded in the lithium-metal layer 212A.

Example Indirect Functional Coatings for Lithium-Metal Layers

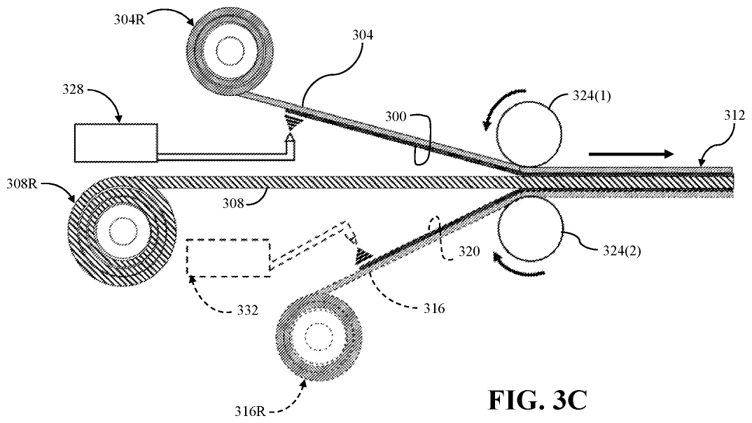

Lithium metal and its oxides are not easily wetted with liquids having surface tension in excess of 25 dynes/cm. Consequently, it is difficult to apply, directly to a lithium-metal layer, a functional coating that is beneficial for the lithium-metal layer. Examples of functional coatings for a lithium-metal layer include a ceramic coating, lithium fluoride coating, and lithium carbonate coating, among others. Referring to FIGS. 3A and 3B, to ameliorate this problem, one or more functional coatings, such as functional coating 300, may be applied to a separator layer 304 prior to the separator layer being laminated to a lithium-metal layer 308 (FIG. 3A). The coated separator layer 304′ is then pressure laminated to the lithium-metal layer 308 to form an anode-subassembly 312 (FIG. 3B), which may either be in a continuous web form or a sheet form, depending on the circumstances. When in sheet form, the anode-subassembly 312 can be used in the direct-stacking process 200 of FIG. 2A.

The process of applying a functional coating for benefiting a lithium-metal layer, such as functional coating 300 applied for lithium-metal layer 308, may be referred to as an “indirect coating process”, since the functional coating is applied directly to a separator layer, here separator layer 304, and then the functional coating is finally contacted with the lithium-metal layer when the separator layer is pressure laminated to the lithium-metal layer. As illustrated in FIGS. 3A and 3B, in some embodiments this indirect coating process may involve only a single (or “first”) separator layer 304 pressure laminated to the lithium-metal layer 308 on only one side of the lithium-metal layer. However, as also illustrated, a second separator layer 316 may be optionally provided, with or without a second functional coating 320. Indeed, one can readily envision modifying the anode-subassembly web-forming process of FIG. 2C to include one or more coating applicators upstream of the pinch rollers 224(1) and 224(2). Such a modified process is illustrated in FIG. 3C.

Referring to FIG. 3C, each of the first separator layer 304, the lithium-metal layer 308, and optional second separator layer 316 may be paid-out from corresponding rolls 304R, 308R, and 316R. Prior to pressure laminating via a pair of pinch rollers 324(1) and 324(2), one, the other, or both of the first and second separator layers 304 and 316 may be coated with at least one corresponding functional coating for the lithium-metal layer 308, here functional coatings 300 and 320, respectively, using one or more coating applicators, here separate coating applicators 328 and 332. Each of the coating applicators 328 and 332 may be of the same or differing type. In some embodiments in which the functional coatings 300 and 320 are composed of the same material(s), a single applicator (not shown) may be used. Each of the coating applicators 328 and 332 may be of any suitable type, such as a spray applicator, brush applicator, dip applicator, etc., depending on the type(s) of functional coating being applied as functional coatings 300 and 320, if present. For convenience only, the coating applicators 328 and 332 are illustrated as spray applicators.

In a specific example, one, the other, or both of the functional coating 300 and 320 may be made using a slurry containing nano-sized aluminum oxide (Al₂O₃, particle size D50=50 nm) and one or more polymer binders, such as poly(vinylidene fluoride-co-hexafluoropropene) (PVDF-HFP), polyacrylonitrile (PAN), polymethylmethacrylate (PMMA), and/or carboxymethyl cellulose (CMC), among others. In some embodiments, the formulation of this alumina may be more than 70% and less than 95%. The slurry may then be dried before further processing, such as pressure lamination as described below.

Example Lithium-Metal Batteries Made Using a Directly Stacked Jellyroll and/or an Indirect Functional Coating

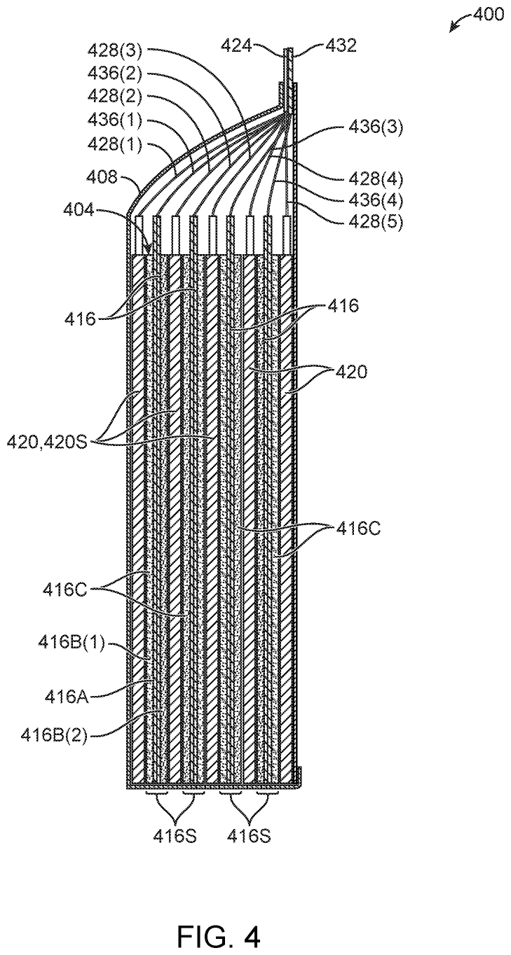

FIG. 4 illustrates an example lithium-metal battery 400 made using a directly stacked jellyroll 404 made in accordance with aspects of the present disclosure. In this example, the directly stacked jellyroll 404 is sealed within a casing, here, a pouch-type casing 408, along with a suitable electrolyte (not illustrated, but present in at least the separator layers 416B(1) and 416B(2)). In other embodiments, the pouch-type casing 408 may be replaced with a casing of a differing type, such as a rigid-wall housing, among others. Fundamentally, the type of casing is important only to the extent that it provides the requisite functionalities, including providing a sealed volume for containing the directly stacked jellyroll 404 and the electrolyte. Those skilled in the art are familiar with techniques and materials for constructing the pouch-type casing 408 or other type of casing that a particular design may include. Consequently, further details on the casing are not necessary herein for those skilled in the art to instantiate the lithium-metal battery 400 without undue experimentation.

Regarding the electrolyte, since in this example the battery 400 is a lithium-metal battery, meaning that the anodes 416 comprise lithium metal to which lithium ions are deposited and stripped during, respectively, charging and discharging cycles, the electrolyte contains lithium ions (not shown) that flow between the anodes and cathodes 420 within the directly stacked jellyroll 404 during the charging and discharging cycles. Consequently, in this example the electrolyte includes one or more lithium-based salts in a suitable form, such as in a solution, an eutectic mixture, or a molten form, among others. In some embodiments, the electrolyte may contain one or more solvents, one or more performance and/or property enhancing additives, and/or one or more polymers, among other things. The electrolyte may be in any suitable state of matter, such as liquid, gel, or solid state. The composition of the electrolyte can be any composition suitable for the particular application at issue and can be determined by the designer of the particular instantiations of the lithium-metal battery 400.

The anodes 416 are provided to the directly stacked jellyroll 404 in anode-subassembly sheets 416S, and the cathodes are provide to the directly stacked jellyroll as cathode sheets 420S. Each anode-subassembly sheet 416S generally includes a lithium-metal layer 416A pressure laminated between first and second separator layers 416B(1) and 416B(2), respectively (only labeled in one of the anode-subassembly sheets 416S to avoid clutter; the others are the same). Each of the anode-subassembly sheets 416S may be the same as or similar to any of the anode subassembly sheets described above, such as any of the embodiments described above in connection with anode subassembly sheets 212 and 212′, which includes a version containing one or more functional coatings for the lithium-metal layer 416A as described above in connection with FIGS. 3A to 3C. In this embodiment, each anode subassembly sheet 416S also includes a current collector layer 416C. Each cathode sheet 420S may be the same as or similar to the cathode sheet 208 of FIG. 2A. The directly stacked jellyroll 404 of FIG. 4 may be made using the direct stacking process 200 of FIG. 2A. Each anode-subassembly sheet 416S may be made using any suitable pressure laminating process, such as the pinch-roller process described above in connection with FIG. 2C. If one or more functional coatings (not shown) for the lithium-metal layer 416A are provided, the coatings may be applied to the corresponding separator layer(s) 416B(1) and 416B(2) in any suitable manner, such as the application process described above in connection with FIG. 3B. It is noted that the number (4) of each of the anode-subassembly sheets 416S and the number (5) of cathode sheets 420S shown are only for convenience. More or fewer of each of the anode-subassembly sheets 416S and cathode sheets 420S may be provided to suit a particular design.

Referring still to FIG. 4, the lithium-metal battery 400 also includes a positive terminal 424 electrically connected to each of the cathodes 420 via corresponding electrodes 428(1) to 428(5). Similarly, the lithium-metal battery further includes a negative terminal 432 electrically connected to each of the anodes 416, here to the current-collector layers 416C, via corresponding electrodes 436(1) to 436(4).

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of making a lithium-metal battery, the method comprising:
assembling a stacked jellyroll, the assembling of the stacked jellyroll including:
providing a plurality of anode-subassembly sheets each comprising a lithium-metal layer pressure laminated between a first separator and a second separator;
providing a plurality of cathode sheets; and
alternatingly stacking the anode-subassembly sheets and the plurality of cathode sheets with one another so as to form the stacked jellyroll.

2. The method of claim 1, further comprising forming the anode-subassembly sheets, wherein the forming includes:
forming a laminated web comprising the first separator, the lithium-metal layer, and the second separator; and
cutting the laminated web so as to form the anode-subassembly sheets.

3. The method of claim 2, wherein forming the laminated web includes contacting the first and second separators with the lithium-metal to form a multilayer structure, and applying pressure to the multilayer structure to form the laminated web.

4. The method of claim 3, wherein applying pressure to the multilayer structure includes feeding the multilayer structure through pinch rollers.

5. The method of claim 1, wherein the first separator includes a functional coating for the lithium-metal layer and the functional coating is in contact with the lithium-metal layer.

6. The method of claim 5, wherein the functional coating includes a ceramic material.

7. The method of claim 5, wherein the functional coating includes lithium fluoride.

8. The method of claim 5, wherein the functional coating includes lithium carbonate.

9. The method of claim 1, further comprising forming the anode-subassembly sheets, wherein the forming includes:
forming a laminated web comprising the first separator, the lithium-metal layer, and the second separator, wherein the first separator includes functional coating in contact with the lithium-metal layer; and
cutting the laminated web so as to form the anode-subassembly sheets.

10. The method of claim 9, wherein forming the laminated web includes contacting the first and second separators with the lithium-metal to form a multilayer structure, and applying pressure to the multilayer structure to form the laminated web.

11. The method of claim 10, further comprising applying the functional coating to a porous separator body so as to form the first separator.

12. The method of claim 11, wherein the functional coating includes a ceramic material.

13. The method of claim 11, wherein the functional coating includes lithium fluoride.

14. The method of claim 11, wherein the functional coating includes lithium carbonate.

15. The method of claim 10, wherein applying pressure to the multilayer structure includes feeding the multilayer structure through pinch rollers.

16. The method of claim 1, further comprising placing the stacked jellyroll in an interior of a casing.

17. The method of claim 16, further comprising adding an electrolyte to the interior of the casing and sealing the casing.

18. The method of claim 1, wherein the lithium-metal layer has a thickness less than 20 microns.

19. The method of claim 18, wherein the lithium-metal layer has a thickness less than 10 microns.

20. The method of claim 1, further comprising a current-collector layer embedded in the lithium-metal layer so that lithium metal is present on both sides of the current-collector layer.
